(19) United States
(12) Patent Application Publication
(10) Pub. No.: US 2015/0276002 A1
(43) Pub. Date: Oct. 1, 2015

(54) Damping Valve Arrangement With A Multistage Damping Force Characteristic

(71) Applicants: Thomas EICHENMÜLLER, Schonungen (DE); Robert MOLLER, Aidhausen (DE); Manuel TREUBERT, Stadlauringen (DE); Udo MARKERT, Wonfurt (DE)

(72) Inventors: Thomas EICHENMÜLLER, Schonungen (DE); Robert MOLLER, Aidhausen (DE); Manuel TREUBERT, Stadlauringen (DE); Udo MARKERT, Wonfurt (DE)

(73) Assignee: ZF FRIEDRICHSHAFEN AG

(21) Appl. No.: 14/667,226

(22) Filed: Mar. 24, 2015

(30) Foreign Application Priority Data
Mar. 28, 2014 (DE) DE102014205855.4

(51) Int. Cl. F16F 9/348

(52) U.S. Cl. CPC F16F 9/348

(57) ABSTRACT

A damping valve arrangement for a vibration damper has a main valve body, a first auxiliary valve body and a second auxiliary valve body with at least two through-flow channels connected hydraulically in parallel for a flow direction of a damping medium. Outlet cross sections of the at least two through-flow channels are influenced by at least one valve disk. The valve bodies are axially fastened to a shared support that extends through the valve bodies and at least one through-flow channel is formed at the support. A first auxiliary valve including the first auxiliary valve body and at least a first valve disk and a second auxiliary valve including the second auxiliary valve body and a, separate valve disk connected through a shared through-flow channel and are hydraulically connected in series such that the amount of damping medium flowing through the second auxiliary valve is limited by the first auxiliary valve.

### BACKGROUND OF THE INVENTION

1. Field of the Invention

The invention is directed to a damping valve arrangement with a multistage damping force characteristic.

2. Description of the Related Art

The object of a vibration damper in a motor vehicle is to damp vibrations due to an uneven road surface. In this regard, there must always be a compromise between driving safety and driving comfort. A vibration damper with a stiff damping valve arrangement having a high damping force characteristic is optimal for highly safe driving. If greater comfort is demanded, the damping valve arrangement should be adjusted to be as soft as possible. It is very difficult to find this compromise in a vibration damper with a conventional, non-electronic damping valve arrangement that is adjustable by an actuator.

A damping valve arrangement with a multistage damping force characteristic having at least four damping force characteristic ranges is known from DE 20 22 021 A1. These damping force characteristic ranges are realized by two damping valves which are connected in parallel and which have different opening behaviors and different choking effects.

DE 17 80 003 A1 discloses a damping valve arrangement which likewise comprises two damping valves with different opening characteristics. A through-flow channel is formed directly in the piston rod as an axial bore. In this way the damping medium is supplied to an auxiliary piston. At a defined excitation frequency of the vibration damper, the supply flow of damping medium to the auxiliary valve is choked and closed off so that the damping characteristic changes.

DE 10 2010 028 841 A1 discloses a damping valve arrangement that has a main valve and an auxiliary valve, which each have separate through-flow channels connected hydraulically in parallel. Both valves are axially fastened to a support. The auxiliary valve is supplied with damping medium through a through-flow bore formed in the support. The main valve and the auxiliary valve are adjusted such that they open after a variably selected damping medium pressure is reached and allow the damping medium to flow through the valve. Accordingly, either only one valve opens or both valves open, which produces a different damping characteristic.

### SUMMARY OF THE INVENTION

It is an object of the present invention to develop a damping valve arrangement with a multistage damping force characteristic that has a simple construction and can be adapted to a predetermined damping force characteristic in a more economical way.

Accordingly, a damping valve arrangement with a multistage damping force characteristic is provided that comprises a main valve body, a first auxiliary valve body and a second auxiliary valve body with at least two through-flow channels connected hydraulically in parallel for a flow direction of a damping medium, wherein outlet cross sections of the at least two through-flow channels are influenced in each instance by at least one valve disk. The valve bodies are axially fastened to a shared support and at least one of the through-flow channels is formed at the support. A first auxiliary valve comprising the first auxiliary valve body, at least a first valve disk and the second auxiliary valve body comprising the second auxiliary valve body, and at least a further separate valve disk are connected to one another through a shared through-flow channel and are accordingly hydraulically connected in series such that the amount of damping medium flowing through the second auxiliary valve is limited by the first auxiliary valve.

According to one embodiment, the first auxiliary valve body and the second auxiliary valve body are constructed so as to be substantially identically shaped. This makes it possible to use identical parts in series production, which reduces costs.

In a very simple and, therefore, also advantageous constructional variant, the main valve body is axially fastened to the shared support between the first auxiliary valve body and the second auxiliary valve body. The valve bodies fastened to the shared support can be clamped together axially at least indirectly in a simple manner by shared fasteners.

To minimize component parts in an advantageous manner, the fasteners can be constructed such that, in addition to the fastening function, they seal at least one end of the through-flow channel formed at the support.

In one embodiment, the support has a cylindrical outer shape and the through-flow channel formed at the support is realized through a partial flattening of the support.

It can be provided that the first valve disk of the first auxiliary valve has through-flow openings. When only one valve disk is used, these through-flow openings can be formed as bores in the disk. On the other hand, if a so-called disk package is used (i.e., a plurality of valve disks stacked one upon the other), the valve disk has at least one radially extending slot. The amount of damping medium flowing through can be adjusted through the selection of the quantity and/or dimensions of the through-flow openings.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be described more fully with reference to the following description of the drawings. In the drawings:

FIG. 1 is a sectional view of a damping valve;

FIG. 2 is a further sectional view of the damping valve;

FIG. 3 is a perspective view of an auxiliary valve body;

FIG. 4 is a bottom view of an auxiliary valve body;

FIG. 5 is a cross-sectional view of an auxiliary valve body; and

FIG. 6 is a top view of a valve disk.

### DETAILED DESCRIPTION OF THE PRESENTLY PREFERRED EMBODIMENTS

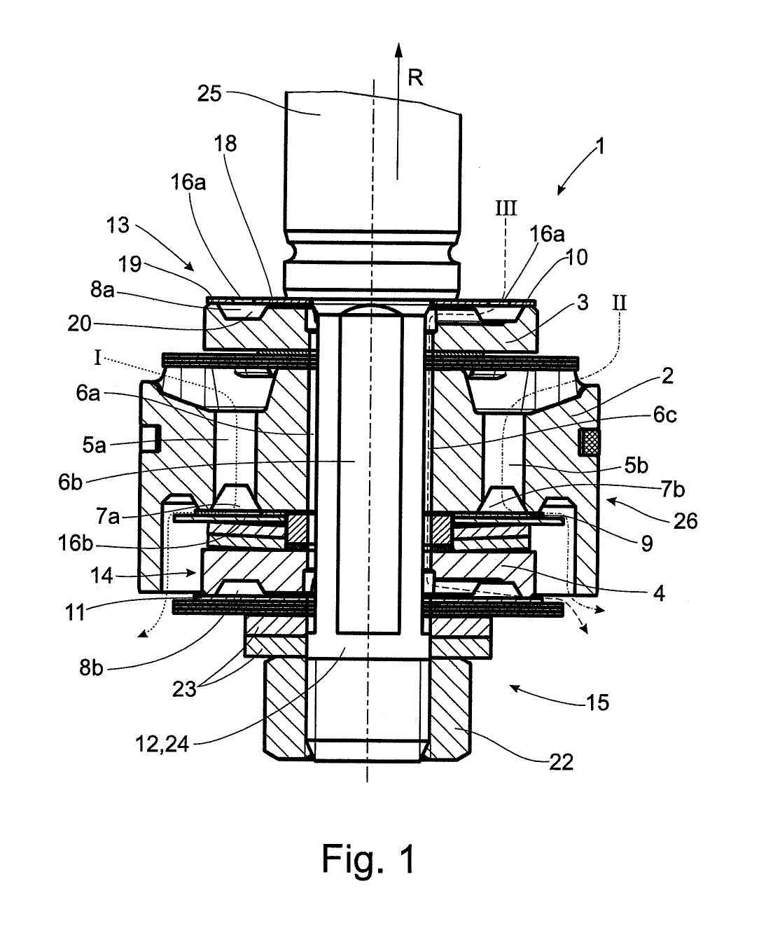

FIG. 1 shows an exemplary constructional variant of a damping valve arrangement with a multistage damping force characteristic.

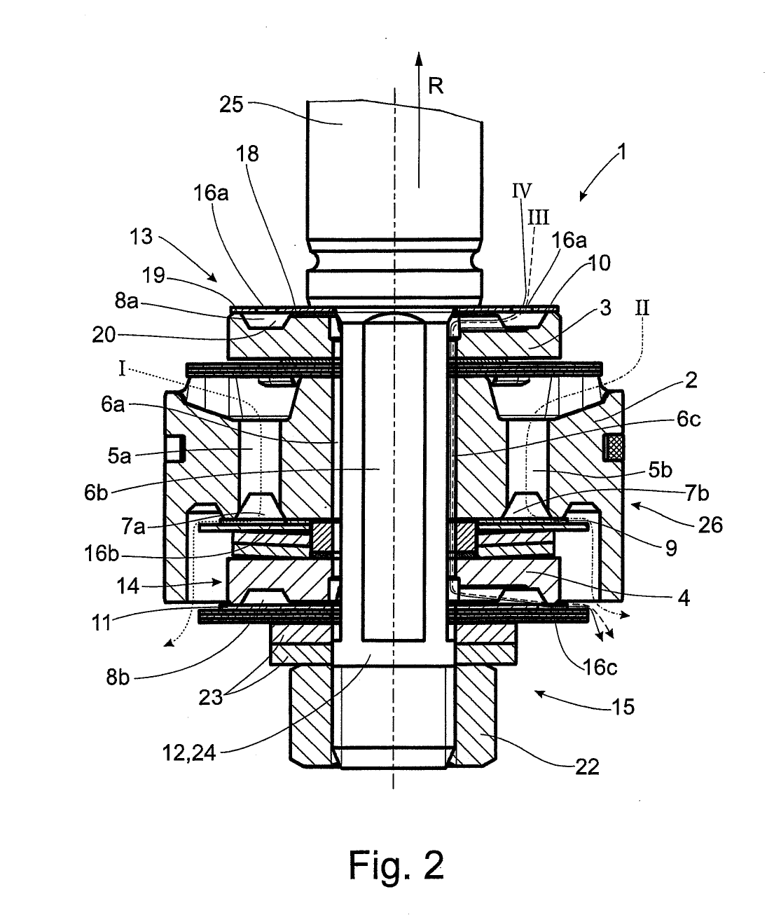

The depicted damping valve device 1 comprises a main valve body 2, a first auxiliary valve body 3, a second auxiliary valve body 4, and a plurality of through-flow channels 5a, 5b, 6a, 6b, 6c connected hydraulically in parallel for a flow direction of a damping medium. The outlet cross sections 7a, 7b, 8a, 8b of the through-flow channels 5a, 5b, 6a, 6b, 6c are influenced respectively by at least one valve disk 9, 10, 11. The valve bodies 2, 3, 4 are axially fastened to a shared support 12, this support 12 extending through the valve bodies 2, 3, 4. As shown in FIG. 1 and FIG. 2, a piston rod neck 24 of a piston rod 25 provides the function of the support 12.

The positions of the valve bodies 2, 3, 4 are selected such that the main valve body 2 is arranged axially between the first auxiliary valve body 3 and the second auxiliary valve body 4 at the shared support 12. The support 12 has a cylindrical basic outer shape and the through-flow channel 6a, 6b, 6c formed at the support 12 is realized by a partial flattening of the support 12. More precisely, the through-flow channels 6a, 6b, 6c are realized at the support 12 through a partial flattening of the cylindrical support 12.

It can further be seen from FIG. 1 and FIG. 2 that the damping valve arrangement has a first auxiliary valve 13 comprising the first auxiliary valve body 3 and at least a first valve disk 10 and a second auxiliary valve 14 comprising the second auxiliary valve body 4 and at least one further, separate valve disk 11. The two auxiliary valves 13, 14 are connected to one another through a shared through-flow channel 6a, 6b, 6c and are accordingly connected hydraulically in series. The amount of damping medium flowing through the second auxiliary valve 14 is limited by the first auxiliary valve 13. FIGS. 1 and 2 further show a main valve 26 which includes the main valve body 2 and a valve disk 9, which axially covers the main valve body 2.

The valve bodies 2, 3, 4 are secured to the shared support 12 and are clamped together axially at least indirectly by a shared fastener 15. The fastener in the instance depicted in FIGS. 1 and 2 comprises a piston nut 22 and at least one compensating disk 23.

As is shown in FIGS. 1 and 2, the shared fastener 15 seals the through-flow channel 6a, 6b, 6c formed at the support 12 at the end of the through-flow channel 6a, 6b, 6c facing the piston nut 22.

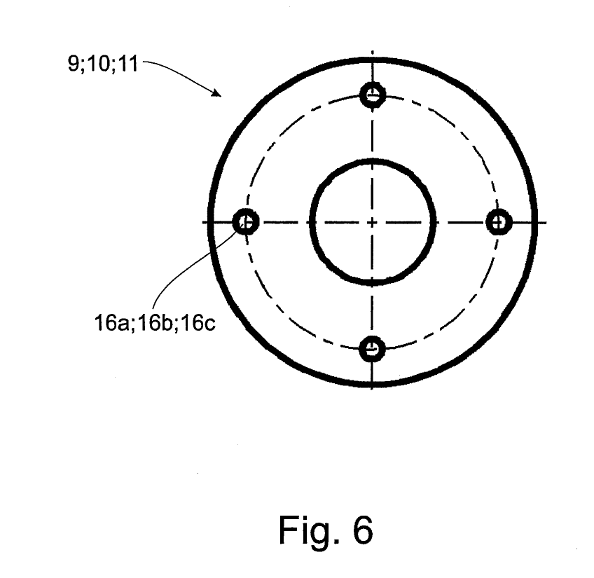

FIG. 1 shows that the valve disk 10 of the first auxiliary valve 13 has a plurality of through openings 16a. In contrast to FIG. 1, FIG. 2 shows a constructional variant of the damping valve arrangement according to one embodiment of the invention in which the valve disk 10 of the first auxiliary valve 13 and the valve disk 11 of the second auxiliary valve 14 both have through-flow openings 16a, 16c. The through-flow openings 16c is formed only at valve disk 11 of second auxiliary valve 14. Likewise, the through-flow opening 16b can be formed at the valve disk 9 of the main valve 26. FIG. 6 shows an example of a valve disk with through-flow openings 16a, 16b, 16c formed therein. The through-flow openings 16a, 16b, 16c can have any shape or size and can also be formed as holes, bores, or slots. The amount of damping medium flowing through can be determined through the selection of the shape and size of the through-flow openings 16a, 16b, 16c.

FIGS. 1 and 2 show that the first auxiliary valve body 3 and the second auxiliary valve body 4 are substantially identically shaped and are arranged at the shared support 12 in a mirror-inverted manner with respect to one another.

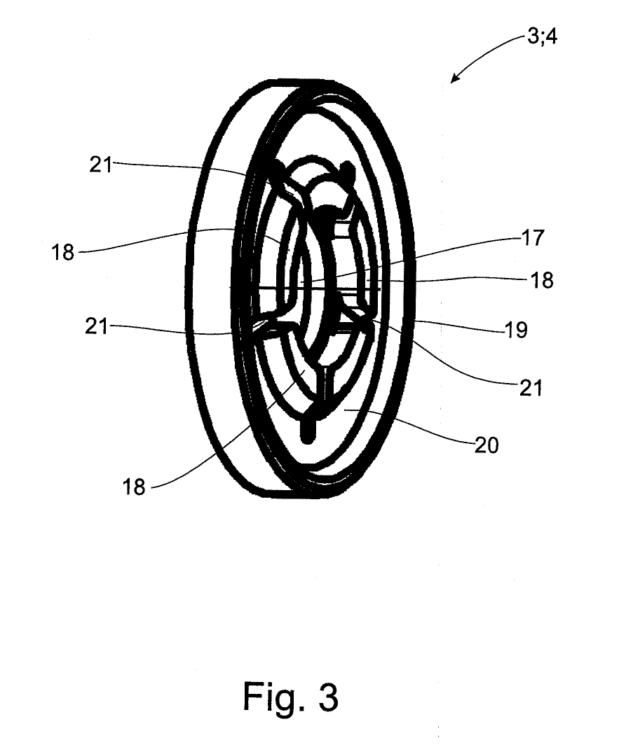

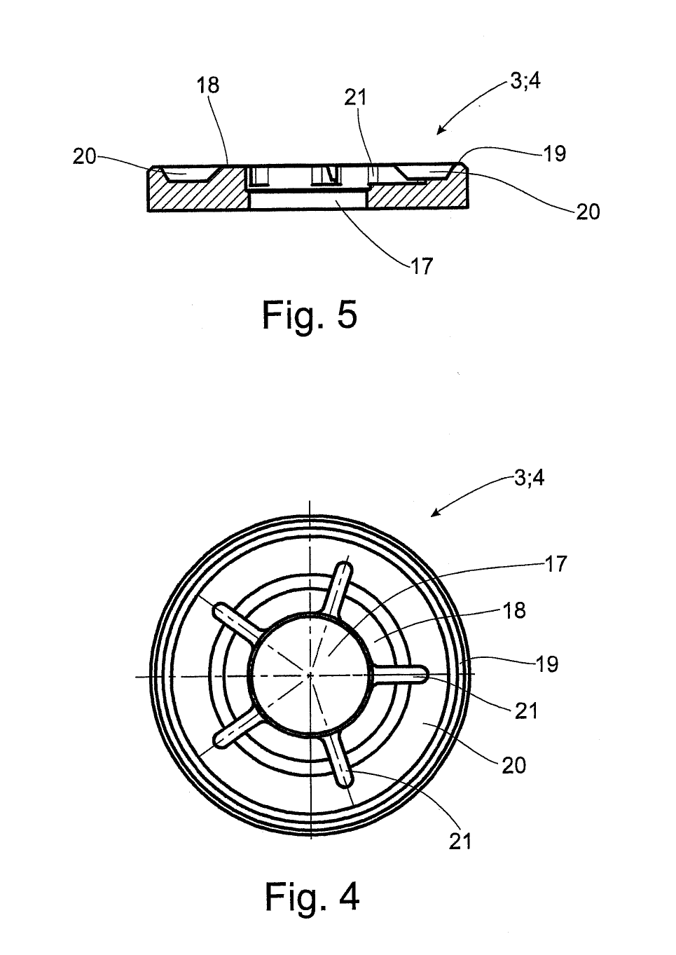

FIGS. 3, 4 and 5 show that the auxiliary valve body 3, 4 has a through-flow opening 17 which is formed radially medially so that the support is guided through. Further, the auxiliary valve body 3, 4 has at least one radially inner contact surface 18 running around the through-flow opening 17 and a contact edge 19 extending circumferentially radially outwardly in the edge region of the auxiliary valve body 3, 4, which contact edge 19 axially supports a valve disk 10, 11. A circumferential annular groove 20 is formed between the contact surface 18 and the contact edge 19 for optimal distribution of damping medium inside the auxiliary valve 13, 14. Further, the auxiliary valve body 3, 4 has a plurality of flow channels 21 which extend radially through the contact surface 18 and connect the through-flow opening 17 to the annular groove 20.

The manner of operation of the damping valve arrangement 1 according to one embodiment of the invention will be described in more detail in the following. The flow of damping medium through the damping valve arrangement 1 on rebound and the different damping medium paths through the damping valve arrangement 1, which influence the damping force characteristic and cause the damping force characteristic stages, will also be described. FIGS. 1 and 2 are referred to for this description. Here, the rebound describes the movement of the damping valve arrangement 1 when the piston rod is pulled out of a damping-medium-filled working cylinder, not shown, of the vibration damper. The direction of this movement is indicated by an arrow R in FIGS. 1 and 2.

During rebound, a difference in pressure causes the damping medium to flow through the damping valve arrangement 1. In so doing, the damping medium flows through the through-flow channels 5a; 5b of the main valve body 2 and passes the through-flow opening 16b arranged in the valve disk 9 of the main valve 26.

When the amount of damping medium flowing through the through-flow channels 5a; 5b of the main valve body 2 exceeds a defined limit, the flowing damping medium opens the valve disk 9 of the main valve 26 and flows through a gap which develops as a result between the valve disk 9 and the main valve body 2. These operating conditions are shown in FIGS. 1 and 2 and are designated by reference numerals I and II.

FIGS. 1 and 2 further show another operating condition III.

In this case, the damping medium flows through the through-flow opening 16a in the valve disk 10 of the first auxiliary valve 13 into the annular groove 20 of the first auxiliary valve body 3. As the pressure difference increases, the damping medium flows through the through-flow channels 6a, 6b, 6c through the annular groove of the second auxiliary valve body 4, opens the valve disk 11 of the second auxiliary valve 14 and flows through a gap which develops as a result between the valve disk 11 and second auxiliary valve body 4.

As the pressure increases, the flow of damping medium is choked in a defined manner through the through-flow opening 16a. Defined choking of the damping medium flow can be adjusted through selection of the size and/or quantity of through-flow openings 16a formed in the valve disk.

FIG. 2 additionally shows a further operating condition IV.

This operating condition occurs when both valve disk 10 of first auxiliary valve 13 and valve disk 11 of second auxiliary valve 14 have at least one through-flow opening 16a, 16c in each instance. In this case, with a slight movement of the support 12, the damping medium can flow through a through-flow opening 16a, 16c, through the through-flow channel 6a, 6b, 6c and through the other through-flow opening 16c, 16a.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A damping valve arrangement (1) for a vibration damper, comprising:
a main valve body (2);
a first auxiliary valve body (3);
a second auxiliary valve body (4);
at least two through-flow channels (5a, 5b, 6a, 6b, 6c) arranged in the a second auxiliary valve body that are connected hydraulically in parallel for a flow direction of a damping medium;
outlet cross sections (7a, 7b, 8a, 8b) of the at least two through-flow channels (5a, 5b, 6a, 6b, 6c) are influenced by at least one valve disk (9, 10, 11); and
a shared support to which the main valve body, the first auxiliary valve body, and the second auxiliary valve body (2, 3, 4) are axially fastened,
wherein the shared support (12) extends through the main valve body, the first auxiliary valve body, and the second auxiliary valve body,
wherein at least one of the through-flow channels (6a, 6b, 6c) is formed at the shared support (12),
wherein a first auxiliary valve (13) comprising the first auxiliary valve body (3) and at least a first valve disk (10) and a second auxiliary valve (14) comprising the second auxiliary valve body (4) and at least a further valve disk (11) are connected to one another through a shared through-flow channel (6a, 6b, 6c) and are hydraulically connected in series such that an amount of damping medium flowing through the second auxiliary valve (14) is limited by the first auxiliary valve (13).

2. The damping valve arrangement for a vibration damper according to claim 1, wherein the main valve body (2) is axially fastened to the shared support (12) between the first auxiliary valve body (3) and the second auxiliary valve body (4).

3. The damping valve arrangement for a vibration damper according to claim 1, wherein the main valve body, the first auxiliary valve body, and the second auxiliary valve body are clamped together axially at least indirectly by a shared fastener (15).

4. The damping valve arrangement for a vibration damper according to claim 3, wherein the shared fastener (15) seals at least one end of at least one through-flow channel (6a, 6b, 6c) formed at the shared support (12).

5. The damping valve arrangement for a vibration damper according to claim 1, wherein the shared support (12) has a generally cylindrical outer shape, and the at least two through-flow channels (6a, 6b, 6c) are formed at the shared support (12) is realized by a partial flattening of the shared support (12).

6. The damping valve arrangement for a vibration damper according to claim 1, wherein at least one of the first valve disk (10) of the first auxiliary valve (13) and the further valve disk (11) of the second auxiliary valve (14) has through-flow openings (16a, 16b, 16c).

7. The damping valve arrangement for a vibration damper according to claim 1, wherein the first auxiliary valve body (3) and the second auxiliary valve body have a substantially identically shaped.

8. The damping valve arrangement for a vibration damper according to claim 1, wherein the first auxiliary valve body (3) and the second auxiliary valve body (4) are arranged at the shared support (12) in a mirror-inverted manner with respect to one another.

9. The damping valve arrangement for a vibration damper according to claim 1, wherein the auxiliary valve body (3, 4) has a through-flow opening (17) formed radially medially so that the shared support is guided through and at least one radially inner contact surface (18) running around the through-flow opening (17) and a contact edge (19) extending circumferentially radially outwardly in an edge region of the auxiliary valve body (3, 4), which contact edge (19) serves to axially support the valve disk and the further valve disk (10, 11),
wherein a circumferential annular groove (20) is formed between the contact surface (18) and the contact edge (19) for optimal distribution of damping medium inside at least one of the first and second auxiliary valves (13, 14).

10. The damping valve arrangement for a vibration damper according to claim 1, wherein the auxiliary valve body (3, 4) has at least one flow channel (21) that extends radially through the contact surface (18) and connects the through-flow opening (17) to an annular groove (20).
